(19) United States
(12) Patent Application Publication
(10) Pub. No.: US 2005/0236905 A1
(43) Pub. Date: Oct. 27, 2005

(54) Telecommunication control system

(76) Inventors: Lincoln Tsai, El Monte, CA (US); Xiao Bing Huang, Shenzhen (CN)

Correspondence Address: RAYMOND Y. CHAN, 108 N. YNEZ AVE., SUITE 128, MONTEREY PARK, CA, 91754, US

(21) Appl. No.: 10/841,021

(22) Filed: May 7, 2004

Related U.S. Application Data
(60) Provisional application No. 60/561,996, filed on Apr. 13, 2004.

(51) Int. Cl. H02B 1/24

(52) U.S. Cl. 307/116; 340/825.72; 340/5.7

(57) ABSTRACT

A telecommunication control system for an electrical appliance, which includes an operation switch and a sensor switch, includes a telecommunicating remote control for communicating with the telecommunication network, wherein the telecommunicating remote control is adapted to receive an access signal through the telecommunication network; and a logic switch electrically linked with the telecommunicating remote control for actuating the electrical appliance when the telecommunicating remote control receives the access signal, wherein the logic switch is adapted to send an actuation signal to the operation switch of the electrical appliance when the electrical appliance is turned on so as to deactivate the electrical appliance, and when the electrical appliance is turned off, the logic switch is idled so as to keep the electrical appliance remains turning off.

### CROSS REFERENCE OF RELATED APPLICATION

This is a regular application of a provisional application Ser. No. 60/561,996, filed on Apr. 13, 2004.

### BACKGROUND OF THE PRESENT INVENTION

1. Field of Invention

The present invention relates to a control system, and more particularly to a telecommunication control system which is capable of communicating with electrical appliances for controlling an operation thereof through telephone signals.

2. Description of Related Arts

Electrical devices, such as typical electrical appliances, usually require manual activation for operation. For example, an operation of a garage gate is usually activated by a remote control unit or a wall switch whereby a user may open or close the garage gate either by pressing the remote control at a distance or by directly pressing the wall switch.

Conventionally, the user merely need to press a single button on the remote control unit for transmitting the operation signal to the garage gate which, depending on the state of the gate, then performs subsequent closing and opening operation of the garage gate. In other words, where the gate is originally closed, a subsequent operation signal from the remote control unit will open the gate. Conversely, where the gate is originally opened, a subsequent operation signal from the remote control unit will close the gate.

As a result, when a user, due to his/her own carelessness, forgets to close the garage gate after he/she driving off the garage, the user has to go back home and close it, perhaps for security reason. This obviously causes great hassle to the user. Moreover, this problem should not be confined only to garage gate, for almost all other electrical appliances need manual operation, though probably through a remote control system.

There exist handfuls of recently developed remote control systems which are capable of remotely controlling electric apparatus via telephone circuit. The electric apparatus are hooked to the telephone circuit such that by inputting a predetermined set of instruction through the telephone circuit, the operation of the electric apparatus can be controlled in a predetermined fashion. For example, when a particular instruction is inputted through the telephone circuit, a particular electric apparatus, such as an air-conditioner, will start operating at once so as to achieve ‘pre-cooling’ to the home. When the user has actually come back home, he/she can enjoy a ‘pre-cooled’ or ‘pre-heated’ environment in his/her home.

However, this kind of ‘remote control device’ is unsatisfactory for controlling garage gate and some other electrical apparatus. First, despite the fact that the user may, by his/her own cellular phone, order to close the garage gate, a practical difficulty arises in which where the user simply forgets whether or not he/she has closed the garage gate, or switched off the air conditioner. In such situation, a further activation of the garage gate may lead to an undesirable result in that if the garage gate is originally closed, the user's remote activation will actually open the garage gate. The consequences of this may lead to trespasser wondering around the garage and may seek opportunity for further criminal behavior, such as conducting criminal damage or theft.

Similar scenario equally appears in some other electrical appliances. Although it may be said that for some electrical appliances, accidental turning on as such mentioned earlier may be immaterial in the sense that it is not a big deal, such as turning on of a television, it is not necessarily the same when, for example, the user accidentally turns on a heater, wherein prolonged operation of which may lead to catastrophic consequences such as fire.

Thus even a layperson may appreciate the above-mentioned inadequacy concerning the conventional remote control systems. Those can merely be suitable for some particular kinds of electric apparatus in which the garage gate's operation is definitely excluded.

### SUMMARY OF THE PRESENT INVENTION

A main object of the present invention is to provide a telecommunication control system which is capable of remotely communicating with an electrical appliance, such as a garage gate, via a telecommunication network so as to remotely control an operation of the electrical appliance.

Another object of the present invention is to provide a telecommunication control system which is capable of ensuring an operation state of the electrical appliance, such as the garage gate, and then operating the electrical appliance in an optimal manner so as to prevent undesirable operation thereof. In other words, for example, when the gate is already closed, subsequent instruction for operating the gate through the telecommunication control system will not eventually open it.

Another object of the present invention is to provide a telecommunication control system which allows controlling of an electrical appliance, such as a garage gate, by inputting instructions to a regular cellular phone or a fixed line phone and transmitted through a wireless or a fixed line telecommunication network so that maximum convenience to the user of the present invention can be enshrined.

Another object of the present invention is to provide a telecommunication control system which does not involve complicated and expensive mechanical or electrical components. As a result, the manufacturing cost and the ultimate selling price of the present invention can be kept minimal.

Another object of the present invention is to provide a telecommunication control system which is easy to implement and compatible with a wide variety of electrical appliances. In other words, a user may be able to self-implement the telecommunication control system for his/her own appliances, such as the garage gate.

Another object of the present invention is to provide a telecommunication control system which does not alter the original electrical circuit of the existing electrical appliance, so as to minimize the manufacturing and running cost of the present invention.

Accordingly, in order to accomplish the above objects, the present invention provides a telecommunication control system for one or more electrical appliances each comprising an operation switch, wherein the telecommunication control system comprises:
a telecommunicating control unit for communicating with the telecommunication network, wherein the telecommunicating control is adapted to receive an access signal through the telecommunication network, and
a logic switch electrically linked with the telecommunicating control for actuating the electrical appliance when the telecommunicating remote control receives the access signal, wherein the logic switch is adapted to selectively send an actuation signal for actuating the electrical appliance, such that the actuation signal is neglected for iding the electrical appliance when the electrical appliance is already switched off, and the actuation signal is authorized for switching off the electrical appliance when the electrical appliance is switched on so as to ensure the electrical appliance to be switched off.

These and other objectives, features, and advantages of the present invention will become apparent from the following detailed description, the accompanying drawings, and the appended claims.

### BRIEF DESCRIPTION OF THE DRAWINGS

FIG. 1 is a schematic block diagram of a telecommunication control system according to a preferred embodiment of the present invention, illustrating that the telecommunication control system is operating with an electrical appliance, such as a typical garage gate.

FIG. 2 is a schematic diagram of the telecommunication control system according to the above preferred embodiment of the present invention, illustrating the logic of controlling a particular electrical appliance, such as the garage gate.

FIG. 3 is a schematic diagram of the telecommunication control system according to the above preferred embodiment of the present invention, illustrating the interaction between the logic switch and different electrical appliances.

FIG. 4 is a schematic circuit diagram of the logic processor of the telecommunication control system according to the above preferred embodiment of the present invention.

FIG. 5 is an alternative mode of the telecommunication control system according to the above preferred embodiment of the present invention, illustrating that the telecommunication control system is used for an air-conditioning system.

FIG. 6 is a schematic diagram of the alternative mode of the telecommunication control system according to the above preferred embodiment of the present invention.

FIG. 7 is a flow diagram of a method of remotely controlling an electrical appliance according to the above preferred embodiment of the present invention.

### DETAILED DESCRIPTION OF THE PREFERRED EMBODIMENT

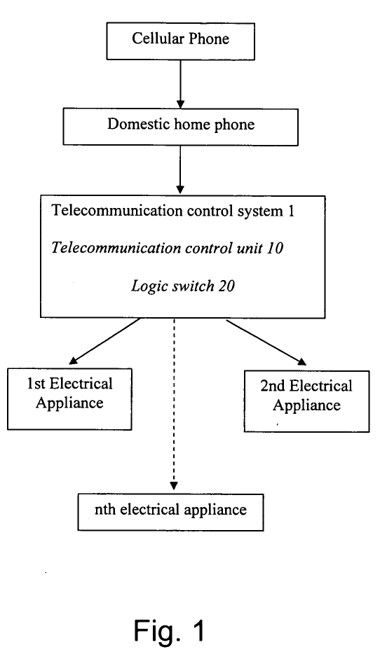

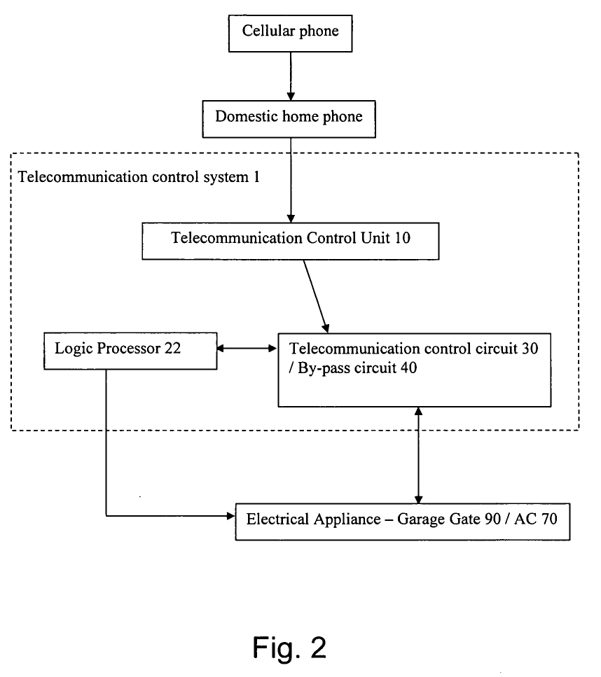

Referring to FIG. 1 to FIG. 2 of the drawings, a telecommunication control system 1 for use in conjunction with an electrical appliance, such as a garage gate 90, through a telecommunication network according to a preferred embodiment of the present invention is illustrated, in which the telecommunication control system 1 comprises a telecommunication control unit 10 and a logic switch 20. Furthermore, the electrical appliance typically comprises an operation switch for controlling an operation of the electrical appliance, and a sensor switch for detecting an operation of the electrical appliance. For instances, in case of a garage gate 90, the operation switch is typically installed in the garage for manually opening or closing the garage gate 90, and the sensor switch is operatively provided thereto in such a manner that the sensor switch would be activated in a predetermined manner so as to identify what is the operation state of the garage gate 90.

The telecommunication remote control 10 is adapted for communicatively connecting with the telecommunication network to receive an access signal through the telecommunication network. According to the preferred embodiment, the telecommunication network is embodied as a regular telecommunication network, such as those provided by the such prominent service provider as SBC in the Southern California, or wireless telecommunication network, such as those provided by such prominent telecommunication network service providers as AT&T, Cingular, T-Mobile etc. In other words, the telecommunication network can be activated via a communication device such as regular telephone or a mobile phone by making a phone call to the telecommunication network.

The logic switch 20 is electrically linked with the telecommunicating control unit 10 for actuating the electrical appliance when the telecommunicating control unit 10 receives the access signal via the telecommunication network, wherein the logic switch 20 is adapted to send an actuation signal for selectively actuating the electrical appliance, such that the actuation signal is neglected for idling the electrical appliance when the electrical appliance is already switched off, and the actuation signal is authorized for switching off the electrical appliance when the electrical appliance is switched on so as to ensure the electrical appliance to be switched off.

In other words, the logic switch 10 is adapted to send the actuation signal to the electrical appliance when the electrical appliance is turned on so as to deactivate the electrical appliance, and when the electrical appliance is turned off, the operation switch is idled so as to keep the electrical appliance remains turning off.

Referring to FIGS. 1 to 2, the telecommunication remote control 10, according to the preferred embodiment, is electrically connected to a fixed line telecommunication network through a regular fixed line telephone, which is capable of communicating with a wireless telecommunication network through the telecommunication network providers. Accordingly, the access signal is initiated by a regular cellular phone which is transmitted through the telecommunication network to the communication remote control 10 for controlling an operation of the electrical appliance, such as the garage gate 90. In other words, the access signal is generated by a touch tone signal to the telecommunication control unit 10 through the telecommunication network. Therefore, the user is able to remotely send out the access signal to the telecommunication control unit 10 through the telecommunication network when the user presses a particular button of the telephone.

Referring to FIG. 1 of the drawings, the telecommunication control unit 10 may be embodied as a control circuit board provided in the telecommunication control system 1 wherein it is electrically connected to the telecommunication network via a regular phone line or cable.

The logic switch 20 is aimed to provide an optimal response to a user's instruction in the form of the access signal. For the sake of terminology clarification throughout this specification, the garage gate 90 is customarily termed ‘turning off’ when it is closed. Conversely, when the garage gate 90 is opened, it is in the sense of ‘turning on’. It is worth to mention that the telecommunication control system 1 of the present invention is adapted to remote control two or more garage gates 90 through the telecommunication network by different actuation signals sent from the logic switch 20. Therefore, the user is able to selectively control one or more garage gates 90 by inputting different actuation signals.

The logic operation of the logic switch 20 can be summarized in table 1 as follows:

TABLE 1
Logic operation of the logic switch

Gate /
Electrical
Appliance

| operation state | Access signal | Actuation |
|---|---|---|
| Opened / On | Closing / Actuating the | Closing the garage gate 90/ |
| | operation switch for turning | turning off the electrical |
| | off the electrical appliance | appliance |
| Closed / Off | Closing / Actuating the | Garage gate 90 remains |
| | operation switch for turning | closed / keeping the |
| | off the electrical appliance | electrical appliance remains |
| | | to be off |

The logic switch 20 comprises a logic processor 21 electrically connected with the operation switch of the electrical appliance to send out the actuation signal, in such a manner that the logic processor 21 sends out the actuation signal for switching off the electrical appliance when the electrical appliance is originally switched on, and the logic switch 20 is idled for keeping the electrical appliance remains switching off when the electrical appliance is originally switched off.

According to the preferred embodiment, the logic processor 21 which is embodied as a CPU, is adapted for carrying out a predetermined logic operation of the operation state of the electrical appliance. For example, when the garage gate 90 is opened, the logic switch 20 is adapted to send the actuation signal to the operation switch of the garage gate for closing thereof, and when the garage gate 90 is already closed, the logic switch 20 is adapted to keep the gate 90 remains closing by idling the operation switch 20 so that the garage gate 90 will not be undesirably actuated to open.

As an example, the logic operation of the logic switch 20 can be demonstrated in the following manner as shown in Table 2:

TABLE 2
Specific keys for the garage operation

| Keys | General Function | Specific Function |
|---|---|---|
| 0 | Password setting/ | Passwords for operating the |
| | system management | logic switch 20 |
| 1 | Opening/Closing first | Turning on the first garage gate |
| | garage gate | |
| 2 | | Turning off the first garage gate |
| 3 | Opening/Closing 2nd | Turning on the 2nd electrical |
| | electrical appliance | appliance |
| 4 | | Turning off the 2nd electrical |
| | | appliance |
| 5 | Opening/Closing 3rd | Turning on the 3rd electrical |
| | electrical appliance | appliance |
| 6 | | Turning off the 3rd electrical |
| | | appliance |
| 7 | Opening/Closing | Turning on the 2nd garage gate |
| | second garage gate | |
| 8 | | Turning off the 2nd garage gate |

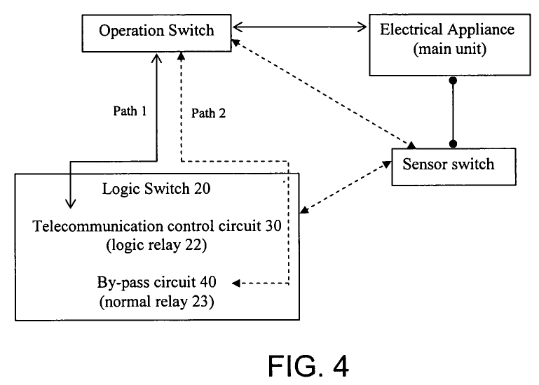

Accordingly, the telecommunication control system 1 further comprises a telecommunication control circuit 30 and a by-pass circuit 40 wherein the user is able to freely select which circuit is to be utilized for controlling the operation of the electrical appliance. Referring to FIG. 4 of the drawings, a schematic diagram illustrating the telecommunication control circuit 30 and the by-pass circuit 40 are shown, wherein the telecommunication control circuit 30 is represented in path 1 and the by-pass circuit 40 is represented in path 2.

Path 1 essentially connects the operation switch of the electrical appliance with the logic processor 21 which further connects with the sensor switch of the electrical appliance. The logic processor 21 further comprises a logic relay 22 which would only send the actuation signal to the electrical appliance when the sensor switch is in a predetermined state, i.e. one which represents the electrical appliance is turned on. Accordingly, the logic relay 22 is connected in path 1 in such a manner that the electrical appliance would only be switched off when it is already turned on. In other words, path 1 is the telecommunication control circuit 30 in which the user of the present invention may operate the electrical appliance remotely from a cellular phone and only close the, say, garage gate 90, when it is opened.

Path 2 essentially connects the logic switch 20 with only the operation switch of the electrical appliance. Accordingly, the logic processor 21 further comprises a by-pass relay 23 which would always send the activation signal to the electrical appliance when the operation switch is activated. In other words, path 2 is the by-pass circuit 40 in which the user of the present invention may operate the electrical appliance in the usual way, i.e. alternate on and off for each actuation of the operation switch.

The operation of the control system device 1 of the present invention is as follows: the electrical appliance, such as the garage gate 90 or any other electrical appliances, is ordinarily controlled by the by-pass circuit 40 via the operation switch. When the user of the garage gate 90 wants to remotely control the closing of it because he/she is not in the vicinity thereof, the user can simply utilize his/her own cellular phone or regular phone for connecting with the telecommunication remote control 10 through the telecommunication network by dialing up a predetermined phone number thereof, such as the user's domestic phone number, and then enter a password for switching to the telecommunication control circuit 30 from the by-pass circuit 40.

Afterwards, the user can be able to input the access signal as instruction for closing the garage gate. When the gate 90 is already closed, the logic switch 20 will keep the garage gate 90 remains closing. However, when the garage gate 90 is opened, the logic switch 20 will send the actuation signal to close the garage gate 90. In other words, the user is able to remotely control closing of his/her home garage gate 90 without fearing the possibility of actually opening the garage gate 90 when an additional actuation signal is inputted. This is especially true when the user is not sure whether the garage gate 90 has been closed or not.

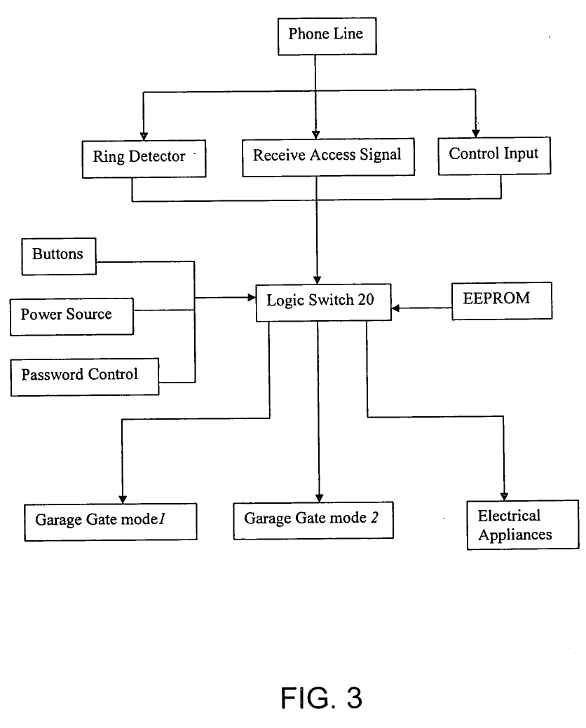

FIG. 3 illustrates an operation example of the telecommunication control system 1 of the present invention, in which the logic switch 20 is electrically connected to the garage gates and the electrical appliance. Moreover, the telecommunication control system 1 is adapted to be controlled through passwords and regular control buttons in the control panel. Moreover, the telecommunication control system 1 is adapted to detect phone rings for receiving the access signal.

According to the preferred embodiment, the telecommunication control system 1 may be utilized in conjunction with more than one electrical appliance, such as a lighting device in the garage, or other domestic appliances such as air-conditioner, television or the likes.

The specific keys for the garage gate 90 operation are designated as shown in Table 1. Hence one skilled in the art would appreciate that the present invention has provided an easy yet effective way of overcoming the above-mentioned discrepancies of the relevant conventional arts.

It is worth to mention that the password as mentioned in the Table 1 may be used to switch the operation of the telecommunication control system 1 from the by-pass circuit 40 to the telecommunication control circuit 30, or vice versa. Moreover, the other keys shown may be used to generate the access signal through the telecommunication network.

As an alternative, where the by-pass circuit is selected, the logic switch 20 may allow an actuation of the electrical appliance without performing the logical operation in the telecommunication control circuit 30. This means that the user is able to turn on or turn off the electrical appliance whenever he/she likes. For example, the user may actually want to turn on his/her air-conditioner before he/she has returned home so as to ‘pre-cool’ his/her home.

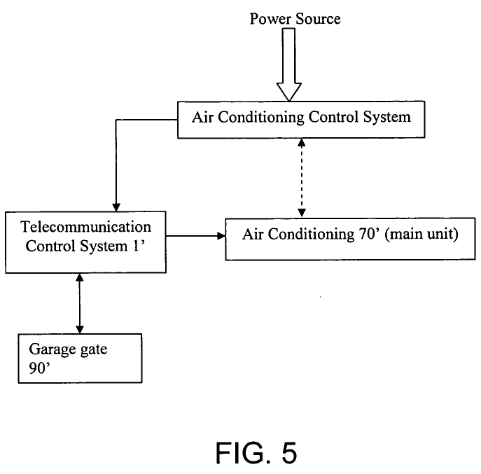

Referring to FIG. 5 of the drawings, an alternative mode of the telecommunication control system 1′ according to the preferred embodiment of the present invention is illustrated, in which the telecommunication control system 1′ is used for an air-conditioning system 70′ comprising an A-C control center 71′, and A-C main unit 72′. According to the alternative mode, the logic switch 20′ is electrically connected with the A-C control center 71′ which is adapted to control an operation of the A-C main unit 72′. The operation of the telecommunication control system 1′ is similar to that of the preferred embodiment in which the user is able to select the by-pass circuit 40′ or the telecommunication control circuit 30′.

In other words, the user is able to switch off the air-conditioning system 70 by making a phone call to the communication control system 1′ through a telecommunication network. In other words, the telecommunication control unit 10′ can be employed for office use. When the user/employee forgets or is not sure whether the air conditioner is switched off or not, the user is always able to switch off the air conditioning system at the office once he/she leaves the office by selecting the telecommunication control circuit 30′, so as to save the electrical energy after office hour.

As a result, an electric transformer may be incorporated into the telecommunication control system 1 in which the electric transformer is electrically connected to the logic switch 20 for delivery of a respective predetermined electric voltage to the respective electrical appliance.

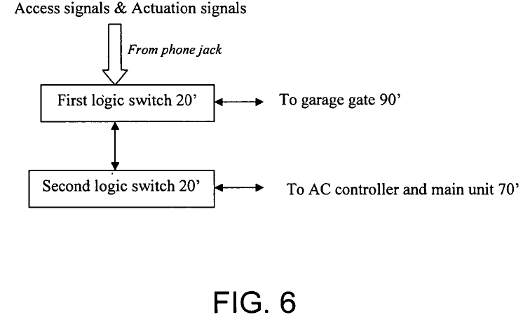

Yet another alternative is that the air-conditioning system 70 and the garage gate 90 may be controlled by two separate logic switch 20 for the sake of easy installation and wire connection, as shown in FIG. 6 of the drawings.

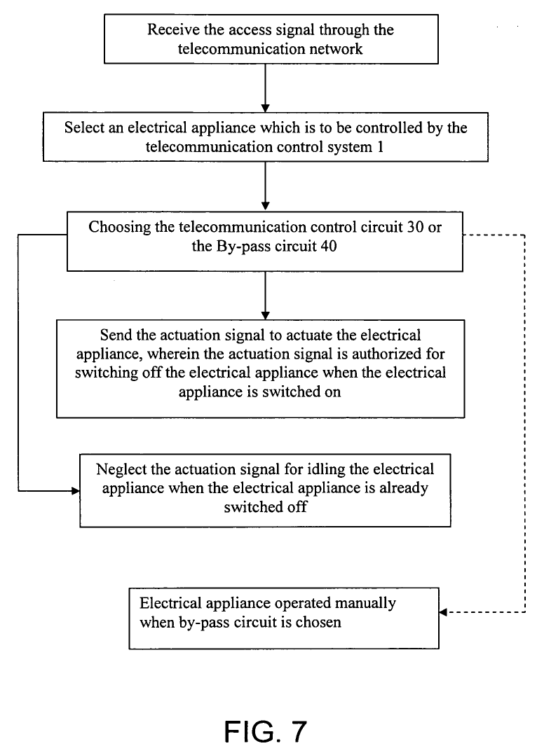

Referring to FIG. 7 of the drawings, a method of remotely controlling an electrical appliance, such as a garage gate 90, according to the preferred embodiment of the present invention is illustrated. The method of remotely controlling the electrical appliance through the telecommunication network comprises the following steps.

(1) Receive the access signal through the telecommunication network.

(2) Detect the electrical appliance whether the electrical appliance is switch on.

(3) Send the actuation signal to actuate the electrical appliance, wherein the actuation signal is authorized for switching off the electrical appliance when the electrical appliance is switched on so as to ensure the electrical appliance to be switched off.

In step (1) above, the access signal is preferably inputted through the user's own cellular phone so that the user is able to gain control of the electrical appliance, such as the garage gate 80 or the air conditioning system 70, while he/she is out on the road or in any places where it has the relevant wireless telecommunication network coverage. Alternatively, the access signal can also be inputted through a fixed line telecommunication network by a regular fixed line telephone.

According to the preferred embodiment, the access signal is generated by a touch tone signal to the telecommunication control unit 10 through the telecommunication network.

It is worth mentioning that when two or more electrical appliances are linked to the telecommunication control unit 10, after the step (1), a selection code should be input by the user through the telecommunication network to select the particular electrical appliance to be remotely operated, and where appropriate, a password is inputted for selecting either the telecommunication control circuit 30 or the by-pass circuit 40.

In step (2) above, the detection of the operation state of the electrical appliance such as the garage gate 90 is preferably performed by utilizing the logic relay 22 and the by-pass relay 23 for controlling an activation of the relevant electrical appliance, or the sensor switch provided in the electrical appliance for, say, ensuring the position of the garage gate 90.

In step (3) above, the actuation is carried out through the above-mentioned logic operation perform by the logic switch 20 of the telecommunication control system 1, as shown in Table 2.

The remote control method of the present invention further comprises a default step of neglecting the actuation signal for idling the electrical appliance when the electrical appliance is already switched off. In other words, it is for the user to choose the telecommunication control circuit 30. As a result, the method of the present invention performs a logic operation by reference to the access signal and the operation state of the electrical appliance. The logic operation is substantially carried out by reference to Table 2. However, it is worth mentioning that certain variation to the above-mentioned logic operation may also be allowed without violating the spirit of the present invention.

Referring to Table 1, when the electrical appliance is originally on, the user is able to actuate the operation switch of the electrical appliance through the telecommunication control system 1 for turning the electrical appliance off. Conversely, when the electrical appliance is originally off, when the user actuates the telecommunication control system 1, it would not turn on the respective electrical appliance, but leaving it idle.

The remote control method further comprises a step of by-passing the actuation signal when the electrical appliance is actuated manually. The step of by passing the actuation signal is executed through the by-pass circuit 40 as it is mentioned above.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1. A telecommunication control system for controlling an electrical appliance, comprising an operation switch and a sensor switch, through a telecommunication network, wherein said telecommunication control system comprises:
a telecommunicating control unit for communicating with said telecommunication network, wherein said telecommunicating control is adapted to receive an access signal through said telecommunication network, and
a logic switch electrically linked with said telecommunicating control for actuating said electrical appliance when said telecommunicating remote control receives said access signal, wherein said logic switch is adapted to selectively send an actuation signal for actuating said electrical appliance, such that said actuation signal is neglected for idling said electrical appliance when said electrical appliance is already switched off, and said actuation signal is authorized for switching off said electrical appliance when said electrical appliance is switched on so as to ensure said electrical appliance to be switched off.

2. The telecommunication control system, as recited in claim 1, wherein said logic switch further comprises a logic processor electrically connected with said sensor switch to send out said actuation signal, in such a manner that said logic processor sends out said actuation signal for deactivating said electrical appliance when said electrical appliance is originally switched on, and said logic switch is idled for keeping said electrical appliance remains switching off when said electrical appliance is originally switched off.

3. The telecommunication control system, as recited in claim 2, further comprising a telecommunication control circuit wherein said operation switch is electrically connected with said logic processor which further connects with said sensor switch of said electrical appliance, wherein said logic processor further comprises a logic relay which is arranged to send said actuation signal to said electrical appliance when said sensor switch is in a predetermined which represents said electrical appliance is turned on.

4. The telecommunication control system, as recited in claim 2, further comprising a by-pass circuit wherein said operation switch is electrically connected with said logic processor which further comprises a by-pass relay which is arranged to send said activation signal to said electrical appliance whenever said operation switch is activated.

5. The telecommunication control system, as recited in claim 3, further comprising a by-pass circuit wherein said operation switch is electrically connected with said logic processor which further comprises a by-pass relay which is arranged to send said activation signal to said electrical appliance whenever said operation switch is activated.

6. The telecommunication control system, as recited in claim 5, wherein said telecommunication control circuit and said by-pass circuit are adapted to be freely selected by a user for remotely controlling, though said access signal, said electrical appliance and manually controlling, though said operation switch, said electrical appliance respectively.

7. The telecommunication control system, as recited in claim 1, wherein said access signal is generated by a touch tone signal to said telecommunication remote control through said telecommunication network.

8. The telecommunication control system, as recited in claim 5, wherein said access signal is generated by a touch tone signal to said telecommunication remote control through said telecommunication network.

9. The telecommunication control system, as recited in claim 6, wherein said access signal is generated by a touch tone signal to said telecommunication remote control through said telecommunication network.

10. A method of remotely controlling an electrical appliance through a telecommunication network, comprising the steps of:
(a) receiving an access signal through said telecommunication network;
(b) detecting said electrical appliance whether said electrical appliance is switch on; and
(c) sending an actuation signal to actuate said electrical appliance, wherein said actuation signal is authorized for switching off said electrical appliance when said electrical appliance is switched on so as to ensure said electrical appliance to be switched off.

11. The controlling method, as recited in claim 10, wherein said step (c) comprises a default step of neglecting said actuation signal for idling said electrical appliance when said electrical appliance is already switched off.

12. The controlling method, as recited in claim 10, further comprising a step of by-passing said actuation signal when said electrical appliance is actuated manually by selecting a by-pass circuit of said logic switch.

13. The controlling method, as recited in claim 11, further comprising a step of by-passing said actuation signal when said electrical appliance is actuated manually by selecting a by-pass circuit of said logic switch.

14. The controlling method, as recited in claim 10, wherein said access signal is generated by a touch tone signal to said telecommunication remote control through said telecommunication network.

15. The controlling method, as recited in claim 12, wherein said access signal is generated by a touch tone signal to said telecommunication remote control through said telecommunication network.

16. The controlling method, as recited in claim 13, wherein said access signal is generated by a touch tone signal to said telecommunication remote control through said telecommunication network.

17. The controlling method, as recited in claim 1, wherein in said step (b), said detection is accomplished by a logic relay and a by-pass relay in said logic processor, as selected by said user, for controlling an activation of said electrical appliance.

18. The controlling method, as recited in claim 14, wherein in said step (b), said detection is accomplished by a logic relay and a by-pass relay in said logic processor, as selected by said user, for controlling an activation of said electrical appliance.

19. The controlling method, as recited in claim 15, wherein in said step (b), said detection is accomplished by a logic relay and a by-pass relay in said logic processor, as selected by said user, for controlling an activation of said electrical appliance.

20. The controlling method, as recited in claim 16, wherein in said step (b), said detection is accomplished by a logic relay and a by-pass relay in said logic processor, as selected by said user, for controlling an activation of said electrical appliance.
